(19) United States
(12) Patent Application Publication
(10) Pub. No.: US 2013/0067349 A1
(43) Pub. Date: Mar. 14, 2013

(54) EFFICIENTLY PROVIDING DATA FROM A VIRTUALIZED DATA SOURCE

(71) Applicants: Ted G. Glaza, Seattle, WA (US); Hamid Mahmood, Seattle, WA (US); Vincent Paul Sibal, Seattle, WA (US); Pranav Goel, Seattle, WA (US); Giacomo Antonio Friedemann Ferrari, Bellevue, WA (US); Terry A. Adams, North Bend, WA (US); Ivan Naranjo Martinez, Redmond, WA (US)

(72) Inventors: Ted G. Glaza, Seattle, WA (US); Hamid Mahmood, Seattle, WA (US); Vincent Paul Sibal, Seattle, WA (US); Pranav Goel, Seattle, WA (US); Giacomo Antonio Friedemann Ferrari, Bellevue, WA (US); Terry A. Adams, North Bend, WA (US); Ivan Naranjo Martinez, Redmond, WA (US)

(73) Assignee: MICROSOFT CORPORATION, Redmond, WA (US)

(21) Appl. No.: 13/230,808

(22) Filed: Sep. 12, 2011

(51) Int. Cl. G06F 3/01; G06F 15/16

(52) U.S. Cl. 715/747

(57) ABSTRACT

Embodiments are directed to implementing data received from a virtualized data source and to efficiently providing data from a virtualized data source. In an embodiment, a computer system user interface (UI) sends a request for data elements to a data source. The computer system receives from the data source an indication that placeholder data is to be displayed while the requested data is retrieved and transmitted. The computer system then displays placeholder data in the UI for each of the requested data elements and dynamically adds the requested data elements to the displayed placeholder data as each data element is received from the data source. The data elements are dynamically added to the UI as they are received from the data source.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are designed to present information to users via various user interfaces. These interfaces may be configured to display data in a variety of different manners, depending on how the application's developer has opted to lay out the data. In some cases, an application user may use the user interface to interact with or request data from a local data source or from a remote data source (e.g. from the internet). In such cases, the user interface (e.g. of the browser) would interact with the underlying application to send a data request to the server. The server would receive that request and respond to the application when possible (e.g. after the data request had risen to the top of a processing queue). While the server is processing the data request, the application typically shows the interface as it was pre-request, or shows nothing at all.

### BRIEF SUMMARY

Embodiments described herein are directed to implementing data received from a virtualized data source and to efficiently providing data from a virtualized data source. In one embodiment, a computer system user interface (UI) sends a request for data elements to a data source. The computer system receives from the data source an indication that placeholder data is to be displayed while the requested data is retrieved and transmitted. The computer system then displays placeholder data in the UI for each of the requested data elements and dynamically adds the requested data elements to the displayed placeholder data as each data element is received from the data source.

In another embodiment, a computer system provides a user-navigable interface that allows a user to navigate through a collection of different data elements stored in a data source. The computer system receives a first navigation input from the user. The navigation input indicates to the data source various data elements that are to be sent to the user based on the first navigation input. The computer system then displays those data elements to which the user has navigated with the first navigation inputs. The computer system receives a second navigation input from the user which indicates to the data source various new data elements that are to be sent to the user based on the navigation input. The computer system also dynamically updates the user-navigable interface with the new data elements as each data element is received from the data source.

In yet another embodiment, a computer system provides a user-navigable interface that allows a user to navigate through a collection of different data elements stored in a data source. The computer system receives a navigation input from the user that indicates to the data source various data elements that are to be sent to the user based on the first navigation input. The computer system then displays those data elements to which the user has navigated with the first navigation inputs. The computer system determines that the navigation input has requested data elements that trigger a request for a subsequent set of data elements to be retrieved from the data source. The computer system then dynamically updates the user-navigable interface with the subsequent set of data elements as each data element is received from the data source.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments of the invention may be realized and obtained by means of the instruments and combinations particularly pointed out in the appended claims. Features of the embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The embodiments of the invention will be described and explained with additional specificity and detail through the use of the accompanying drawings in which:

FIG. 1 illustrates a computer architecture in which embodiments of the present invention may operate including implementing data received from a virtualized data source.

FIG. 2 illustrates a flowchart of an example method for implementing data received from a virtualized data source.

FIG. 3 illustrates a flowchart of an example method for efficiently providing data from a virtualized data source.

FIG. 4 illustrates a flowchart of an alternative example method for efficiently providing data from a virtualized data source.

FIGS. 5A and 5B illustrate embodiments in which data elements are loaded in a classic and in an incremental manner, respectively.

### DETAILED DESCRIPTION

Embodiments described herein are directed to implementing data received from a virtualized data source and to efficiently providing data from a virtualized data source. In one embodiment, a computer system user interface (UI) sends a request for data elements to a data source. The computer system receives from the data source an indication that placeholder data is to be displayed while the requested data is retrieved and transmitted. The computer system then displays placeholder data in the UI for each of the requested data elements and dynamically adds the requested data elements to the displayed placeholder data as each data element is received from the data source.

In another embodiment, a computer system provides a user-navigable interface that allows a user to navigate through a collection of different data elements stored in a data source. The computer system receives a first navigation input from the user. The navigation input indicates to the data source various data elements that are to be sent to the user based on the first navigation input. The computer system then displays those data elements to which the user has navigated with the first navigation inputs. The computer system receives a second navigation input from the user which indicates to the data source various new data elements that are to be sent to the user based on the navigation input. The computer system also dynamically updates the user-navigable interface with the new data elements as each data element is received from the data source.

In yet another embodiment, a computer system provides a user-navigable interface that allows a user to navigate through a collection of different data elements stored in a data source. The computer system receives a navigation input from the user that indicates to the data source various data elements that are to be sent to the user based on the first navigation input. The computer system then displays those data elements to which the user has navigated with the first navigation inputs. The computer system determines that the navigation input has requested data elements that trigger a request for a subsequent set of data elements to be retrieved from the data source. The computer system then dynamically updates the user-navigable interface with the subsequent set of data elements as each data element is received from the data source.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmissions media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

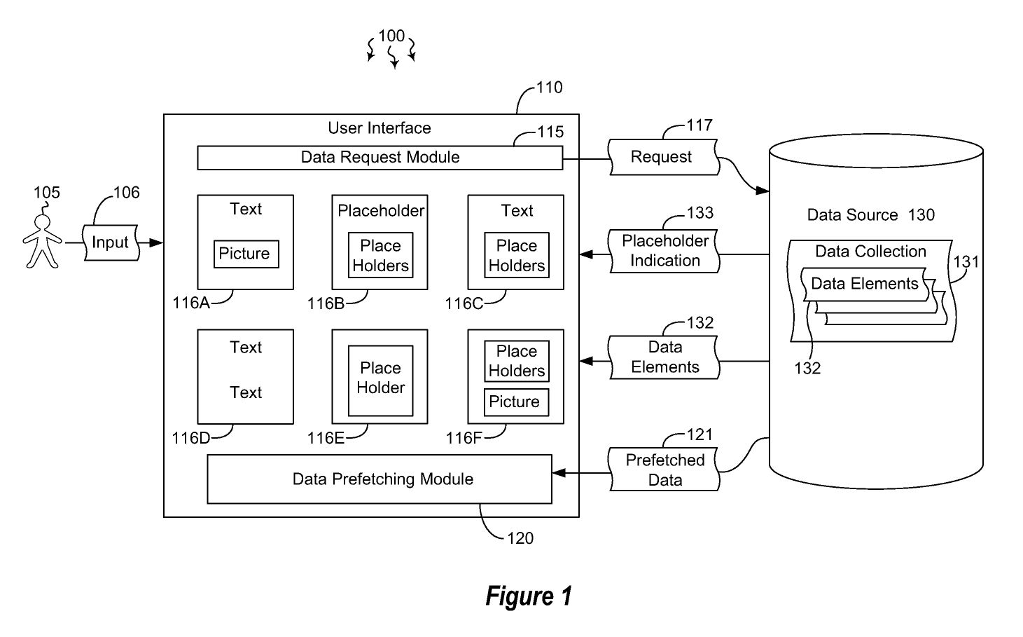

FIG. 1 illustrates a computer architecture 100 in which the principles of the present invention may be employed. Computer architecture 100 includes user interface 110. The user interface (UI) may be an interface for any type of software application, and may receive various different types of user inputs including mouse, keyboard, touchscreen and other inputs. The applications (and the UI itself) may be run on a computer system that is local or distributed (e.g. a cloud computing system). The UI may be configured to interact with a data source 130. The data source may store the data, or may simply act as a proxy that forwards data requests 117 on to the actual location where the data is stored. The data source 130 may include multiple different data collections 131, each of which includes various different data elements 132. These data elements may be virtualized on the data source, and may be sent to the UI in any order. Thus, when a user requests data, the data may be sent as it becomes available, in any order.

In some embodiments, controls may be provided that support working with a virtualized data source via interfaces implemented by the data source. Various different modes of data virtualization may be used. In one example, a “classic” mode may be used, where the data in the collection appears if the entire data collection is loaded. The control then fetches more data as the user navigates. In some cases, additional data in the data collection may be prefetched so it will be ready if the user wants to access it (e.g. by navigating to it). In another example, an “incremental” mode may be used, where the collection data is incrementally grown by fixed size increments as a user approaches the end of the collection (either the very end or a certain number of pages from the end).

Classic data virtualization, as described herein, allows the data source 130 to return a placeholder value while the actual data is retrieved (e.g. by starting an asynchronous request to fetch the data). The control will display placeholder data in the UI for the data item while the actual data is retrieved. In this manner, the collection appears to be fully present (or fully downloaded) even though only a portion of the data has been loaded. Optionally, a prefetching interface may be implemented which requests a block of items that aren't being displayed but will likely be displayed soon.

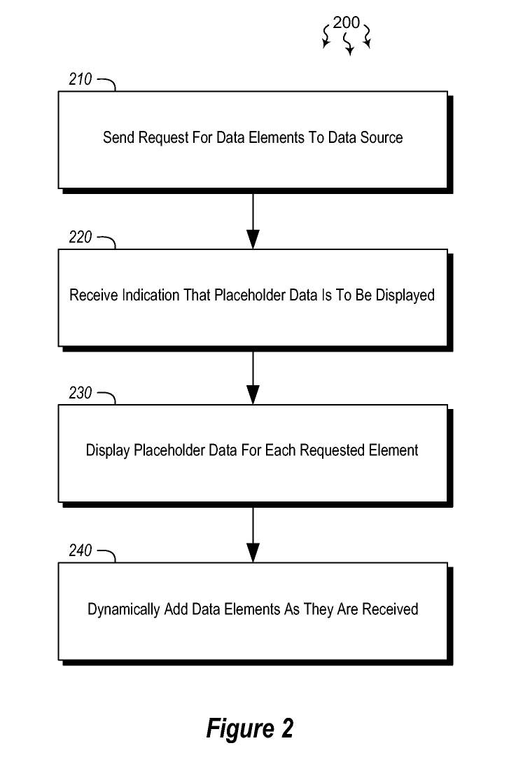

Incremental data virtualization loads a predetermined amount of data and then retrieves subsequent blocks of data items as needed. The incremental data control will listen for customizable triggers (e.g. at the end of the collection, N pages from the end of the collection, or when manually invoked) and trigger the request for the next set of data items. Optionally, placeholder data may be shown in the UI for the items as they are being requested. In some cases, the data source 130 may support both types of data virtualization at the same time (e.g. a search data source that allows users to browse all (or substantially all) resulting search results in one big list, or allows them to get the pages one page at a time). In such cases, the control will determine which mode to use (or both modes when desired). These concepts will be explained further below with regard to methods 200, 300 and 400 of FIGS. 2, 3 and 4, respectively.

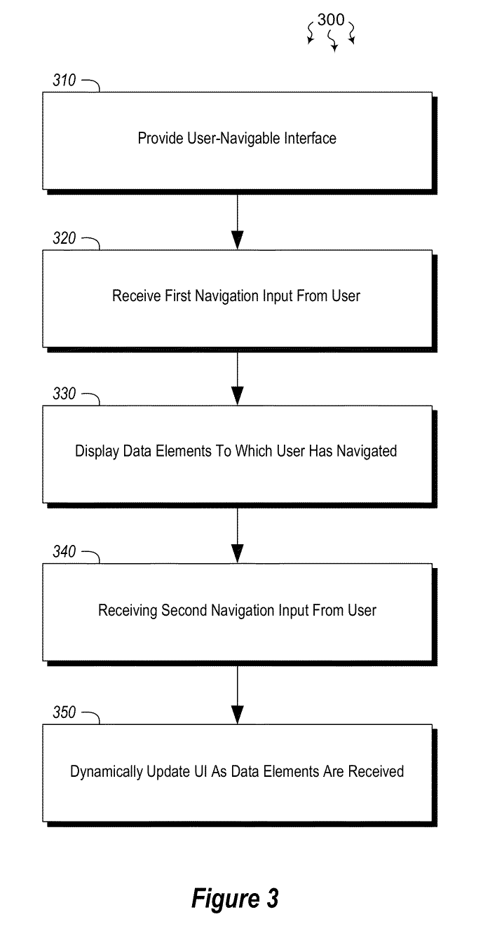

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for implementing data received from a virtualized data source. The method 200 will now be described with frequent reference to the components and data of environment 100.

Method 200 includes an act of a user interface (UI) sending a request for one or more data elements to a data source (act 210). For example, data request module 115 of UI 110 may send request 117 for various data elements 132 of data collection 131. The data elements may be any type of text, picture, video or other type of data. These data elements are stored in data source 130. The data source may be local or remote, and may be a single or a distributed storage solution (e.g. a storage area network (SAN)). Accessing data from a local data source may include readying local files on a hard disk (or on another type of computer-readable media). It should also be noted that both the classic and the incremental data virtualization (as described above) may be implemented for local data sources as well as for remote data sources. The data element request 117 may be sent as a result of receiving input 106 from user 105, where the input indicates that the user desires to view data elements in the collection.

Method 200 also includes an act of receiving from the data source an indication that placeholder data is to be displayed while the requested data is retrieved and transmitted (act 220). For example, UI 110 may receive placeholder indication 133 from the data source 130. The placeholder indication may be any type of data, code, function, signal or other indicator that placeholder data is to be displayed while the requested data is retrieved. The placeholder itself may take on different shapes and forms depending on what the UI maker/user determines. For instance, if the data elements are movies in a movie collection, the placeholders may be grey boxes or movie box outlines or some other image or portion of text that indicates that the actual data is yet to come.

Next, method 200 includes an act of displaying placeholder data in the UI for each of the requested data elements (act 230). User interface 110 may display placeholder data for each of the six data elements shown in the UI (as will be understood, substantially any number of data elements may be displayed in the UI). Thus, as shown in element 116B, placeholders may be shown in place of text and an image. As the data is received from the data source, it may be automatically filled in. Thus, as shown in element 116A, the picture and text have been received and are being displayed. Similarly, in element 116D, two portions of text have been received. In element 116E, no data element has been received, so only a placeholder is shown. In element 116F, a picture has been received on the bottom, but the picture on the top has not been received. Element 116C shows a situation where text has been received, but the picture below it has not been received. While pictures and text are used in FIG. 1, it should be noted that any type of data element may be displayed and used in UI 110.

Method 200 further includes an act of dynamically adding the requested data elements to the displayed placeholder data as each data element is received from the data source (act 240). As data elements 132 are received from the data source 130, they can be dynamically added or “popped-in” as they are received (and, at least in some cases, in the order they are received). The UI (or the computer system running the UI) may determine that the user has stopped interacting with the data elements (116A-F) for a predetermined time. Once it has been determined that the user is viewing the elements (or at least isn't navigating to new elements), data prefetching module 120 may prefetch subsequent data elements from the data source 130. Thus, in cases where a collection includes many hundreds, thousands or millions of documents, and the first six are displayed on UI 110, the data prefetching module may prefetch elements seven through ten, for example. The number of prefetched elements 121 may be customizable per user, per computer system, per application or per some other policy.

While the user is viewing the requested data elements, the UI may determine that the user 105 has interacted with one or more of the data elements within a predetermined time. The interaction may indicate that new data elements are to be loaded and displayed. As a result, any data prefetching that is not yet complete may be cancelled, and the new data elements may be requested from the data source 130. In some cases, data prefetching may be automatically initiated when the data elements of a given data collection are n pages from the end of the collection (where “n” is a customizable variable). Data prefetching may also be automatically initiated when the last data elements of a given data collection are shown on the UI. Thus, if a user has browsed to the end of the data collection, data at the beginning of the collection may be prefetched, in anticipation that the user will return to the beginning The data may also be prefetched when an initiation indication is received from the user, indicating that a certain data elements are to be displayed, while other elements are prefetched. In this manner, prefetched data may be used to enhance the user's data element browsing experience.

FIG. 3 illustrates a flowchart of a method 300 for efficiently providing data from a virtualized data source. The method 300 will now be described with frequent reference to the components and data of environment 100.

Method 300 includes an act of providing a user-navigable interface that allows a user to navigate through a collection of different data elements stored in a data source (act 310). For example, a computer system can provide user interface 110 which allows user 105 to navigate through data collection 131. The data collection may include many different data elements 132 of different types. The data collection may be one of many different data collections stored on data source 130. The UI is configured to receive navigation inputs 106 from the user. The navigation input may indicate to the data source various data elements that are to be sent to the user based on the navigation input (act 320). For instance, if the data collection is a collection of cooking recipes, the user may be navigating between the different recipe pictures and accompanying text. In some cases, the recipes may include videos or other web content. These elements to which the user has browsed may be displayed in the UI (act 330).

As mentioned above, the data may be requested and received at different times. Consequently, the data source 130 may send a placeholder indication 133 to the UI, indicating to the UI that it is to display placeholder data for each of the requested elements. Then, as the data elements are received from the data source, they can be automatically and dynamically added to the UI. Thus, data elements 116A-116F show different stages of receiving data. In element 116A, both text and picture data have been received and are displayed. In element 116B, neither text nor picture have been received and, as a result, placeholder data is displayed for each. In the other elements shown, either none, some or all of the data elements have been received. As the user scrolls or otherwise navigates (e.g. via a hyperlink) to other data elements in the collection, placeholder data for these new elements may be displayed as their corresponding data is retrieved. In this manner, the collection of data elements appears to be fully loaded on the user-navigable interface, while in fact, only a portion of the collection has been transmitted from the data source.

Method 300 further includes an act of receiving a second navigation input from the user, the second navigation input indicating to the data source one or more new data elements that are to be sent to the user based on the navigation input (act 340). Thus, user 105 may send a second input 106 to the UI indicating that new, different data elements from the collection are to be displayed. For instance, if the initially returned data elements are hyperlinks from a web search, and the second input indicates that additional results are to be shown, the UI may send request 117 to data source 130 requesting the additional data elements. The data source may send placeholder indications 133 for the new data elements, and begin transmitting the newly requested data.

The UI may also request that one or more additional data items be prefetched. The prefetching may be automatic, it may be automatic once certain triggers are met, or it may be performed when manually requested. The computer system may determine which data elements or pages are most likely to be subsequently viewed by the user. Those pages may be prefetched while the user is viewing and/or interacting with the currently displayed elements. The prefetch triggers may be user-customizable, at least in some embodiments, and may include any one or more of the following: reaching n pages from the end of the data collection (where “n” is a variable number), reaching the end of the data collection and receiving a manual user indication that data is to be prefetched.

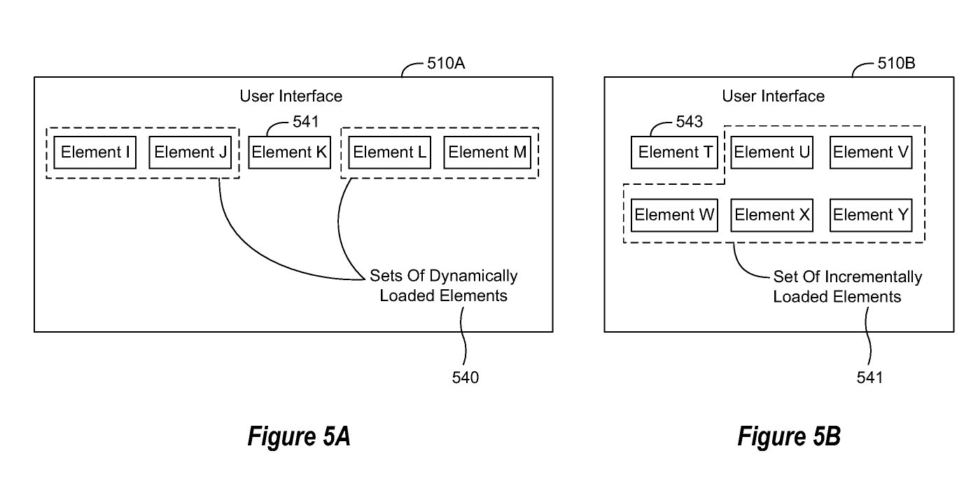

Thus, continuing the example above, the computer system may determine that the second navigation input has requested data elements that trigger a request for a subsequent set of data elements to be retrieved from the data source 130. The UI may then be dynamically updated with the subsequent set of data elements as each data element is received from the data source (act 350). Accordingly, as shown in FIG. 5A, if a user is viewing element K (541) in UI 510A, elements I, J, L and M (540) may be dynamically loaded around element K. Thus, as a user browses, data elements are continually loaded around the currently-viewed element.

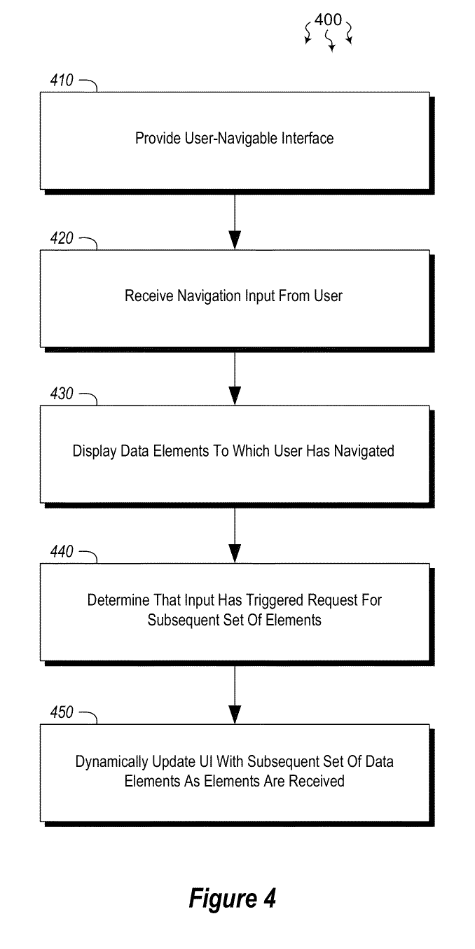

FIG. 4 illustrates a flowchart of an alternative method 400 for efficiently providing data from a virtualized data source. The method 400 will now be described with frequent reference to the components and data of environment 100.

Method 400 includes an act of providing a user-navigable interface that allows a user to navigate through one or more of a plurality of different data elements stored in a data source (act 410). For example, a computer system may provide UI 110, which allows users to interact with an underlying software application. This application may be configured to display and/or allow interaction with the data elements 132 of data collection 131. The UI is configured to receive navigation inputs or other forms of interaction from the user 105 (act 420). The navigation input may indicate to the data source which data elements that are to be sent to the user based on the navigation input (act 420). Thus, after receiving the input from the user, data request module 115 may send request 117 to the data source to retrieve those data elements requested by the user.

Method 400 also includes an act of displaying those data elements to which the user has navigated with the first navigation inputs (act 430). Thus, for instance, as shown in FIG. 5B, if a user has navigated to element T (543), the user interface 510B may display element T, along with other incrementally loaded elements (i.e. elements U, V, W, X and Y (541)). If the data for each data element has not yet been entirely received, placeholder data may be displayed for each element (or each portion of data within the data element).

Method 400 further includes an act of determining that the navigation input has requested data elements that trigger a request for a subsequent set of data elements to be retrieved from the data source (act 440). Thus, once one of the triggers has been met, the new set of elements is incrementally loaded. The trigger may include any of the following: reaching n pages from the end of the data collection (where “n” is a variable number), reaching the end of the data collection and receiving a manual user indication that data is to be prefetched. Accordingly, in FIG. 5B, element T may be within 10 pages of the end of the collection (assuming that the collection ends in element Z). If the variable “n” was 10, then the trigger would be met and the next (configurable) number of incrementally loaded elements would be loaded. These elements are then dynamically updated on the UI 510B, as each data element is received from the data source (act 450). In this manner, data elements are incrementally and dynamically loaded as the user browses or interacts with a data collection.

Accordingly, methods, systems and computer program products are provided which display and allow interaction with data received from a virtualized data source. Moreover, methods, systems and computer program products are provided which efficiently provide data from a virtualized data source to a user through a user interface.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one processor and a memory, in a computer networking environment including a plurality of computing systems, a computer-implemented method for implementing data received from a virtualized data source, the method comprising:
an act of a user interface (UI) sending a request for one or more data elements to a data source;
an act of receiving from the data source an indication that placeholder data is to be displayed while the requested data is retrieved and transmitted;
an act of displaying placeholder data in the UI for each of the requested data elements; and
an act of dynamically adding the requested data elements to the displayed placeholder data as each data element is received from the data source.

2. The method of claim 1, wherein the placeholder data comprises a predefined portion of data that represents a corresponding data element.

3. The method of claim 1, wherein the data elements are dynamically added in the order they are received.

4. The method of claim 1, further comprising:
an act of determining that the user has stopped interacting with the data elements for a predetermined time; and
an act of prefetching one or more subsequent data elements from the data source.

5. The method of claim 4, further comprising:
an act of determining that the user has interacted with one or more of the data elements within a predetermined time; and
an act of cancelling the data prefetching.

6. The method of claim 4, wherein the number of pages to prefetch is customizable by the user.

7. The method of claim 1, wherein data prefetching is automatically initiated when the data elements of a given data collection are n pages from the end of the collection.

8. The method of claim 1, wherein data prefetching is automatically initiated when the last data elements of a given data collection are shown on the UI.

9. The method of claim 1, wherein data prefetching is initiated upon receiving an initiation indication from the user.

10. A computer program product for implementing a method for efficiently providing data from a virtualized data source, the computer program product comprising one or more computer-readable storage media having stored thereon computer-executable instructions that, when executed by one or more processors of the computing system, cause the computing system to perform the method, the method comprising:
an act of providing a user-navigable interface that allows a user to navigate through a collection of different data elements stored in a data source;
an act of receiving a first navigation input from the user, the navigation input indicating to the data source one or more data elements that are to be sent to the user based on the first navigation input;
an act of displaying those data elements to which the user has navigated with the first navigation inputs;
an act of receiving a second navigation input from the user, the second navigation input indicating to the data source one or more new data elements that are to be sent to the user based on the navigation input; and
an act of dynamically updating the user-navigable interface with the new data elements as each data element is received from the data source.

11. The computer program product of claim 10, further comprising prefetching one or more data elements based on one or more prefetch triggers.

12. The computer program product of claim 11, wherein those pages determined most likely to be subsequently viewed by the user are prefetched upon the occurrence of at least one of the prefetch triggers.

13. The computer program product of claim 11, wherein the prefetch triggers comprise at least one of the following: reaching n pages from the end of the data collection, reaching the end of the data collection and receiving a manual user indication that data is to be prefetched.

14. The computer program product of claim 10, further comprising displaying placeholder data for one or more data elements until those data elements are received from the data source.

15. The computer program product of claim 10, wherein the collection of data elements appears to be fully loaded on the user-navigable interface.

16. The computer program product of claim 10, further comprising:
an act of determining that the second navigation input has requested data elements that trigger a request for a subsequent set of data elements to be retrieved from the data source; and
an act of dynamically updating the user-navigable interface with the subsequent set of data elements as each data element is received from the data source.

17. The computer program product of claim 16, further comprising displaying placeholder data for each requested subsequent set of data elements until the sets' corresponding data is received from the data source.

18. A computer system comprising the following:
one or more processors;
system memory;
one or more computer-readable storage media having stored thereon computer-executable instructions that, when executed by the one or more processors, causes the computing system to perform a method for efficiently providing data from a virtualized data source, the method comprising the following:
an act of providing a user-navigable interface that allows a user to navigate through one or more of a plurality of different data elements stored in a data source;
an act of receiving a navigation input from the user, the navigation input indicating to the data source one or more data elements that are to be sent to the user based on the navigation input;
an act of displaying those data elements to which the user has navigated with the first navigation inputs;
an act of determining that the navigation input has requested data elements that trigger a request for a subsequent set of data elements to be retrieved from the data source; and
an act of dynamically updating the user-navigable interface with the subsequent set of data elements as each data element is received from the data source.

19. The computer system of claim 18, further comprising an act of displaying placeholder data in the UI for each of the requested data elements in the subsequent set of data elements.

20. The computer system of claim 18, wherein those pages determined most likely to be subsequently viewed by the user are prefetched upon the occurrence of at least prefetch triggers, the prefetch triggers comprising at least one of the following: reaching n pages from the end of the data collection, reaching the end of the data collection and receiving a manual user indication that data is to be prefetched.
